(19) United States
(12) Patent Application Publication
(10) Pub. No.: US 2014/0133265 A1
(43) Pub. Date: May 15, 2014

(54) Contactless Magnetically Driven Agitation Systems

(71) Applicant: INTERMOLECULAR, INC., San Jose, CA (US)

(72) Inventors: Aaron T. Francis, San Jose, CA (US); Peter Satitpunwaycha, Sunnyvale, CA (US); John Schmidt, Oakland, CA (US)

(73) Assignee: INTERMOLECULAR, INC., San Jose, CA (US)

(21) Appl. No.: 13/673,560

(22) Filed: Nov. 9, 2012

(51) Int. Cl. B01F 13/08

(52) U.S. Cl. CPC B01F 13/08
USPC 366/273

(57) ABSTRACT

Provided are liquid agitating systems having magnetically actuated agitating members that do not come in contact with internal surfaces of liquid holding vessels. As such, some mechanically weak materials, such as polytetrafluoroethylene and perfluoroalkoxy polymer, may be used for internal surfaces of these vessels. An agitating member may be held by a supporting member that allows the agitating member to move within a vessel without touching its bottom. The supporting member effectively controls the distance between the agitating member and some supporting point. An external magnet provided under the vessel may be used for magnetic actuation. The agitating member includes an internal magnet that is magnetically coupled to the external magnet and that follows the path of the external magnet thereby moving the agitating member and agitating the liquid. In some embodiments, multiple external magnets may be used to position one or more agitating member.

### TECHNICAL FIELD

The present invention relates generally to semiconductor processing and more specifically to contactless magnetically driven agitation systems.

### BACKGROUND

To achieve the desired performance enhancement for each successive generation of integrated circuits (ICs), semiconductor manufacturing has become increasingly reliant on new materials and their integration into advanced process sequences. Unfortunately, typical semiconductor manufacturing equipment is not well suited for materials exploration and integration. Issues impacting the use of typical semiconductor manufacturing equipment include difficulty in changing process materials and chemicals rapidly, limited ability to integrate and sequence multiple materials or chemicals in a single reactor or process chamber, high equipment cost, large sample size (300 mm wafer) and inflexible process/reactor configurations. Traditional manufacturing tools need to be complimented with equipment that facilitates fast testing of new materials and materials processing sequences over a wide range of process conditions.

### SUMMARY

Provided are liquid agitating systems having magnetically actuated agitating members that do not come in contact with internal surfaces of liquid holding vessels. As such, some mechanically weak materials, such as polytetrafluoroethylene and perfluoroalkoxy polymer, may be used for internal surfaces of these vessels. An agitating member may be held by a supporting member that allows the agitating member to move within a vessel without touching its bottom. The supporting member effectively controls the distance between the agitating member and some supporting point. An external magnet provided under the vessel may be used for magnetic actuation. The agitating member includes an internal magnet that is magnetically coupled to the external magnet and that follows the path of the external magnet thereby moving the agitating member and agitating the liquid. In some embodiments, multiple external magnets may be used to position one or more agitating member.

### BRIEF DESCRIPTION OF THE DRAWINGS

To facilitate understanding, the same reference numerals have been used, where possible, to designate common components presented in the figures. The drawings are not to scale and the relative dimensions of various elements in the drawings are depicted schematically and not necessarily to scale. Various embodiments can readily be understood by considering the following detailed description in conjunction with the accompanying drawings, in which:

FIG. 1 is a substrate processing system (SPS), in accordance with some embodiments.

FIG. 2 is a flow diagram for combinatorial process sequence integration, in accordance with some embodiments.

FIG. 3 is a combinatorial process sequence integration process flow that includes site-isolated processing and/or conventional processing, in accordance with some embodiments.

FIG. 4 is a block diagram of the integrated processing tool, referred to herein as a Multiple Channel Site-Isolated Reactor (MCSIR), in accordance with some embodiments.

FIG. 5 is a site-isolated processing module (SIPM) of a MCSIR, in accordance with some embodiments.

FIG. 6 shows couplings between a subset of components of the SIPM, in accordance with some embodiments.

FIG. 7 is a schematic illustration of an agitating system including an agitating member supported inside a vessel by a supporting member and magnetically coupled to an external magnet, in accordance with some embodiments.

FIGS. 8A and 8B are top schematic views of agitating systems having rotatable and fixed attachments of the supporting member, in accordance with some embodiments.

FIG. 9 is a schematic illustration of an agitating system including multiple agitating members magnetically coupled to multiple external magnets, in accordance with some embodiments.

FIGS. 10A-10D illustrate top schematic views of different agitating members, in accordance with some embodiments.

FIG. 11 is a process flowchart corresponding to a method of agitating a liquid using an agitating member, in accordance with some embodiments.

### DETAILED DESCRIPTION

A detailed description of various embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

### INTRODUCTION

Liquid stirring systems that utilize magnetic stirring bars are commonly used for agitating liquids. Such stirring systems require minimal hardware components that need to be submerged into liquids and typically only a stirring bar is submerged into a liquid and positioned on the bottom of a container. As such, fewer components are exposed to mixing environments. However, conventional magnetic stirring bars may severely damage containers or, more specifically, bottoms of the containers. While most chemical containers are made from resilient glass, some chemical environments need containers formed or lined with various polymer materials, such as polytetrafluoroethylene (PTFE). These materials are often much less robust than glass and susceptible to mechanical damage. A magnetic stirring bar can exert substantial forces on the bottom of the container caused by its own weight, magnetic field, and rotation resulting in damage to the bottom and release of undesirable particles into a stirred liquid. Often relatively strong magnets are used to ensure magnetic coupling between the steering bar and external driving magnet particularly for viscous liquids and/or high mixing speeds, which only increases possible damage to containers and contamination of liquids.

Provided are liquid agitating systems having magnetically actuated agitating members that do not come in contact with internal surfaces of liquid holding vessels. An agitating member may be held by a supporting member, which allows the agitating member to move within a vessel without touching its bottom. In other words, the agitating member is suspended yet allowed to move within the vessel creating the stirring or agitation action. The supporting member controls the distance between the agitating member and a supporting point. An external magnet provided under the vessel may be used for moving the agitating member within the vessel due to magnetic coupling between the external magnet and the internal magnet, the internal magnet being provided within the agitating member. Specifically, the internal magnet or, more generally, the agitating member follows the path of the external magnet and causes agitation of the liquid within the vessel as in a conventional magnetic stirrer. However, in the described system, the agitating member does not come in contact with the bottom of the vessel. The contact with side walls is avoided by controlling the path of the external magnet.

Because there is no contact between internal surfaces of the vessel and the agitating member, the internal surfaces may be formed from various mechanically weak (but chemically stable) materials, such as poly tetrafluoroethylene (PTFE) and perfluoroalkoxy (PFA) polymer. The same materials may be used for external surfaces of the agitating member, e.g., for encapsulating the internal magnet and defining the shape of the agitating member. As such, decoupling the vessel and agitating member by providing some space between the two allows using new materials for vessels and agitating members without increasing the risk of contamination.

### HPC Methodology and Multiple Channel Site-Isolated Reactors

An integrated processing tool, referred to herein as a multiple channel site-isolated reactor (MCSIR), is described below. The MCSIR includes a full-wafer processing module and a combinatorial site-isolated processing module. The integrated processing tool may be used for mixed-mode processing between full-substrate and multiple site-isolated regions of the full substrate. As such, chemicals for use in the processing modules are fed from a common delivery system that includes a set of manifolds that generate multiple solutions having variable compositions. More specifically, composition of these solutions can be varied in a combinatorial manner. These different compositions may be formed from a set of constituents, delivery of which is controlled by the systems and specified in recopies provided into the system. To allow thorough solution mixing as well as accurate temperature and pH control, the output of each first manifold is coupled to mixing vessels. The output of each mixing vessel is subsequently dispensed to one or more of a set of second manifolds, which deliver a solution from this mixing vessel to one or more reactors of the processing modules. In addition to providing solutions that are mixed statically in mixing vessels, the second set of manifolds allows multiple chemicals to be distributed simultaneously to facilitate dynamic, in-line mixing of solutions.

The MCSIR may integrate multiple independently-controlled process chambers, each representing an independent site isolation region of the full substrate. The MCSIR allows mixing and dispensing different chemical solutions (e.g., multiple solutions having different composition) onto the same substrate simultaneously and/or in sequence. Furthermore, the MCSIR allows independently varying flow and/or solution composition to any number of reactors or one or more subsets of reactors. The MCSIR provides the ability to synchronize process steps and control critical timing across all site-isolated reactors when a global parameter for the process sequence requires this type of synchronization for non-site-isolated control parameters (e.g., temperature of the wafer substrate, reactor height/volume, and the like).

By providing multiple independently controlled and plumbed reactors or process chambers across a single substrate (e.g., 200-, 300-, or 450-mm silicon substrate), the MCSIR described herein addresses the issues that cause traditional semiconductor manufacturing equipment to not be well suited for materials exploration and integration. The configuration and flow dynamics of each site-isolated reactor is typically scaled from a production reactor, facilitating process scale-up to full wafers with minimal changes to the process integration sequence. In addition, materials delivery systems of the MCSIR are configured to allow greater flexibility in both the number of materials that are provided to the chamber as well as the steps in process sequence that are utilized to effect the materials integration. Reactor miniaturization and relaxed equipment requirements for materials research and integration also reduces the cost of the equipment compared to production tools.

Systems and methods for processing a substrate (e.g., forming material(s) on a substrate) are described below. The systems and methods for processing substrates, collectively referred to herein as “substrate processing systems” (SPSs), include combinatorial processing, combinatorial process sequences integrated with conventional substrate processing, and/or site-isolated processing, as described in detail below. The SPS of an embodiment enables production of very small structures and features on substrates (e.g., at the nanometer size scale) at very low cost, which can be useful in the commercial manufacturing of a variety of products, such as electronic components and flat panel displays to name a few. The various systems and methods described below are presented as examples only and are not intended to limit the systems and methods described and claimed herein to particular combinations of combinatorial processing, combinatorial process sequences integrated with conventional substrate processing, and/or site-isolated processing. Furthermore, the systems and methods described below are not limited to particular processes (e.g., wet processes, dry processes, etc.).

In the following description, numerous specific details are introduced to provide a thorough understanding of, and enabling description for, embodiments of the SPS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The SPS may include at least one interface configured to receive at least one substrate. The SPS may also include a number of modules coupled to the interface. The modules, also referred to herein as components, include a pre-processing module, a processing module, and a post-processing module, but may include any number and/or type of other modules where any of the modules may include functions of the pre-processing, processing, and/or post-processing modules. The SPS is not required to include at least one of each of any particular module type. Also, functions of all of the pre-processing, processing, and post-processing modules may be embedded within a single module. Each module of the multiple modules can contain at least one of a number of different processes as appropriate to processes contained in at least one other of the modules. The SPS also includes at least one handler coupled to the interface and configured to move the substrate between the interface and one or more of the modules.

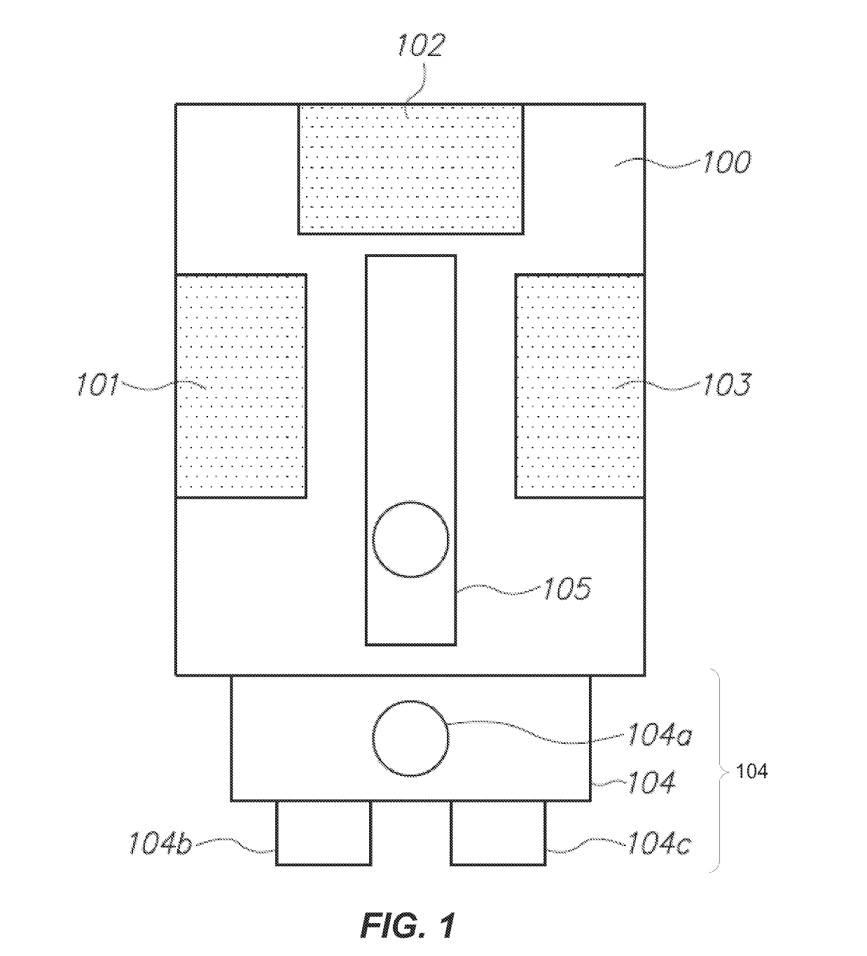

FIG. 1 is an SPS 100, in accordance with some embodiments. The substrate processing system 100 includes a pre-processing module 101, a processing module 102, and a post-processing module 103. The SPS 100 is not required to include at least one of each of the preceding module types. For example, a particular process flow may include only the processing module 102 and features for moving a substrate into and out of the system 100. Also, functions of all of the pre-processing, processing, and post-processing modules may be provided within a single module. The modules 101, 102 and 103 can each be implemented using an apparatus (in particular, conventional commercial substrate processing apparatus) as appropriate to the types of substrate processing for which the modules 101, 102 and 103 are to be used. The modules 101, 102, and 103 can be implemented with modification(s) and/or addition(s) depending on the particular characteristics of the substrate and/or processes.

Substrates enter and leave the system 100 via a system interface 104, also referred to as a factory interface 104. A single substrate can be processed at one time in the system 100 or multiple substrates can be processed at one time in a batch. The system interface 104 includes a substrate handler 104a, which can be implemented, for example, using a robot. The substrate handler 104a moves substrate(s) into and out of the system 100. To facilitate moving the substrates into and out of the system 100, the system interface 104 also includes a substrate load station 104b and a substrate unloading station 104c. These stations may be also referred to as a Front Opening Unified Pod (FOUP) load station 104b and a FOUP unload station 104c, respectively.

After substrate(s) that have been processed are removed from the system 100 and placed on the substrate unload station 104c (for eventual movement to another location) by the substrate handler 104a, new substrate(s) that have previously been placed on the substrate load station 104b are taken from the substrate load station 104b by the substrate handler 104a and moved into the system 100 for processing. The system interface 104 (including the substrate handler 104a, substrate load station 104b and substrate unload station 104c) can be implemented using conventional apparatus and methods known to those skilled in the art of processing substrates. The system 100 of one or more alternative embodiments can include multiple system interfaces, each of which can be constructed and operate as described above.

Once in the system 100, a substrate handling system 105 can be used to move substrate(s) processed by the system 100 between different modules 101, 102, and 103 of the system 100. Like the substrate handler 104a of the system interface 104, the substrate handling system 105 can be implemented, for example, using one or more robots. If the modules 101, 102, and 103 include both wet and dry processing modules, then the substrate handling system 105 includes at least two types of apparatus: a dry substrate handler for moving substrate(s) into and out of dry processing modules and the system interface 104 and out of a drying module, and a wet substrate handler for moving substrate(s) into and out of wet processing modules and into a drying module. The substrate handling system 105 can be implemented using apparatus and methods known to those skilled in the art of processing substrates.

Other than when substrate(s) are being moved into or out of the system 100 through the system interface 104, the system 100 is sealed from the external environment. Depending on the processing to be performed by the system 100, the environment within the system 100 that is outside of the pre-processing module 101, processing module 102, and post-processing module 103 (for convenience, sometimes referred to hereinafter as the “system environment”) can be maintained at atmospheric pressure, held at a vacuum pressure, and/or pressurized (i.e., held at a pressure above atmospheric pressure). Similarly, the system environment can be maintained at the ambient temperature of the environment outside of the system 100, or at a temperature that is higher or lower than that ambient temperature.

Further, the gaseous composition of the system environment can be controlled as desired. For example, the system environment can be ambient air (typically, controlled to reduce contamination from the external environment). The system environment can also be controlled to include, in whole or in part, a specified gas or gases, e.g., in a system used to process semiconductor wafers, the system environment can be controlled to be nitrogen or an inert gas. The system environment can also be controlled to exclude a specified gas or gases, e.g., oxygen can be excluded from the system environment to reduce the occurrence of oxidation of substrate(s) (or material(s) formed thereon) processed in the system.

The SPS of an alternative embodiment can include different types of modules used to process a single wafer or single batch of wafers. Therefore, multiple versions of the SPS can operate in parallel as a single system. This approach can improve the throughput of substrates processed by the SPS. This approach can also add redundancy so that system availability can be maintained even when one or more of the modules of the system are rendered non-operational for a period of time (e.g., for preventative maintenance, repair, etc.).

The SPS described above is presented as an example, and systems including other numbers of processing modules can be used. Furthermore, types of processing modules other than those described above can be used. Manual loading and unloading of substrate(s) may be used in some processing systems instead of a substrate handler for moving substrate(s) into and out of the system.

The SPS 100 described above can include one or more modules (also referred to as components) and/or methods for combinatorially processing regions on a single substrate. Generally, an array of regions is combinatorially processed by delivering processing materials to one or more regions on a substrate and/or modifying the regions. The regions on a substrate of an embodiment include but are not limited to pre-defined regions and regions identified during and/or as a result of processing of the substrate.

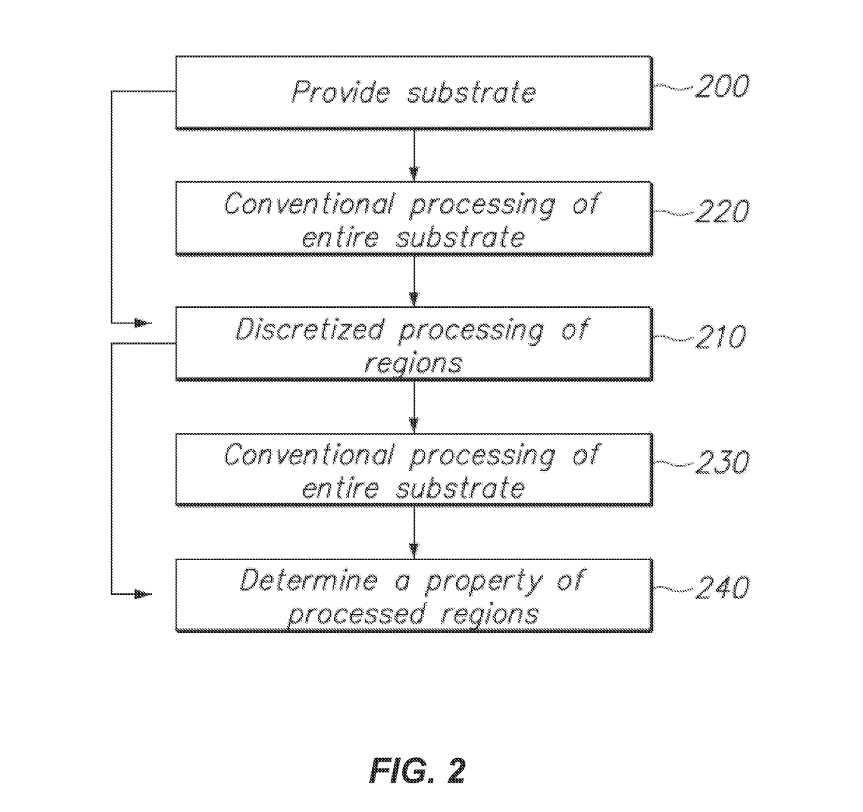

FIG. 2 is a flow diagram for combinatorial process sequence integration, in accordance with some embodiments. The embodiment may utilize a processing tool (which may or may not be an integrated tool comprised of discrete unit modules which collectively perform the effective unit process) that will perform the desired process for analysis. In one embodiment, the processing tool can perform the process in a discretized fashion within unique regions contained in a single monolithic substrate, such as a 300 mm diameter wafer used in IC manufacturing. The substrate is provided to the system during operation 200, and is processed in a discretized (e.g., site isolated) manner during operation 210. The processing of different sited may be performed either in sequence, parallel, or serial-parallel mode. At least two regions of the same substrate are processed differently from each other during operation 210. The substrate processed in the combinatorial fashion can optionally be processed in a conventional manner, before (as reflected by operation 220) and/or after (as reflected by operation 230) discretized processing (operation 210). For purposes of this disclosure, the conventional processing is defined as processing in which the entire or substantially close to the entire substrate (or, more specifically, the working surface of the substrate) is subject to the same processing conditions. This allows the described combinatorial processing/combinatorial process sequence integration approach to be used in desired segments of the process flow required to build an end device(s), integrated circuit, etc.

The processed regions, such as devices or portions of devices created on the substrate surface, can be tested 240 for a property of interest using conventional methods for analysis. Some examples of testing methods include parametric testing for properties, such as yield, via resistance, line resistance, capacitance, and the like, and/or reliability testing for properties, such as stress migration, electromigration, bias thermal stress, time dependent dielectric breakdown. Other testing techniques known to those of skill in the art may be used as well. The processed regions can be tested simultaneously, sequentially, or in a parallel-serial mode, where a first plurality of regions is simultaneously tested, followed by a second plurality of regions being simultaneously tested. The testing (operation 240) is optionally performed in one or more alternative embodiments of the methodology for combinatorial process sequence integration.

The combinatorial process sequence integration of an embodiment uses a processing tool referred to herein as a site-isolated processing tool, which may be also referred to as a site-isolated reactor (SIR). The SIR performs one or more processes. In one embodiment, the site-isolated processing tool processes a substrate in a discretized isolated fashion (either in a serial, parallel, or serial-parallel mode) within unique regions of the substrate (e.g., at least two regions of the substrate are processed differently from each other).

In some embodiments, a method under the combinatorial process sequence integration described herein receives a substrate after completing one of the following processes: depositing, patterning, etching, cleaning, planarizing, implanting, and treating. The method generates a processed substrate by processing at least one region of the substrate differently from at least one other region of the substrate. The processing includes modifying at least one region, wherein modifying includes at least one of physical modifications, chemical modifications, electrical modifications, thermal modifications, magnetic modifications, photonic modifications, and photolytic modifications. The processing forms at least one array of differentially processed regions on the substrate. In some embodiment, the processing described above includes modifying using at least one of materials, processing conditions, process sequences, process sequence integration, or process sequence conditions. In some embodiments, the processed substrate described above is subjected to at least one additional process, such as depositing, patterning, etching, cleaning, planarizing, implanting, and treating.

In some embodiments, a method under the combinatorial process sequence integration described herein generates a processed substrate by processing at least one region of the substrate differently from at least one other region of the substrate. The processing includes modifying at least one region, wherein modifying includes at least one of physical modifications, chemical modifications, electrical modifications, thermal modifications, magnetic modifications, photonic modifications, and photolytic modifications. The processing forms at least one array of differentially processed regions on the substrate. The method continues by providing the processed substrate to at least one additional process selected from a group including depositing, patterning, etching, cleaning, planarizing, implanting, and treating. In one embodiment, the processing described above includes modifying using at least one of materials, processing conditions, process sequences, process sequence integration, and process sequence conditions.

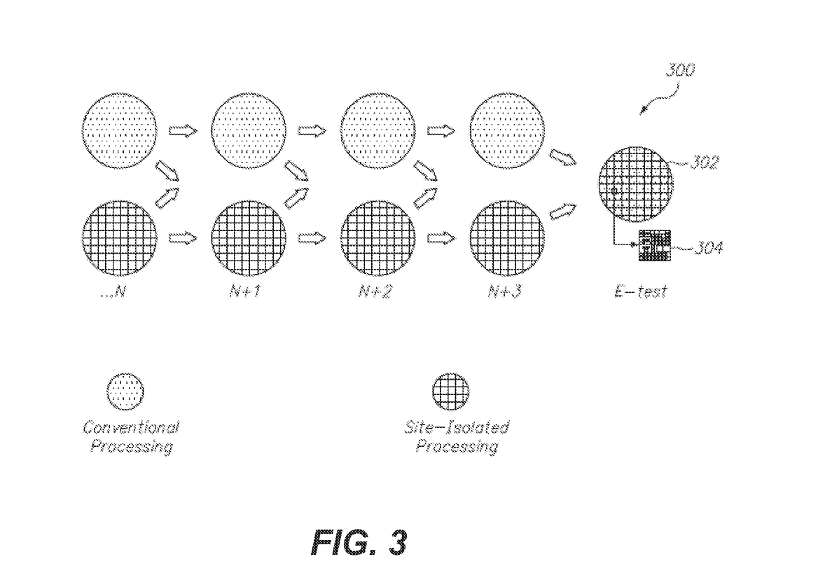

FIG. 3 is a combinatorial process sequence integration process flow 300 that includes site-isolated processing and/or conventional processing, in accordance with some embodiments. A processing sequence may include processing the substrate using Conventional Process N, then processing the substrate using Site-Isolated Process N+1, then processing the substrate using Site-Isolated Process N+2, then processing the substrate using Conventional Process N+3, then perform E-test (e.g., electrical testing). Another example of a processing sequence may involve processing the substrate using Site-Isolated Process N, then processing the substrate using Site-Isolated Process N+1, then processing the substrate using Conventional Process N+2, then processing the substrate using Site-Isolated Process N+3, and then performing E-test. Yet another example of a processing sequence involves processing the substrate using Site-Isolated Process N, then processing the substrate using Conventional Process N+1, then processing the substrate using Site-Isolated Process N+2, then processing the substrate using Conventional Process N+3, and then performing E-test. Various other processing sequences can be implemented according to the process flow 300.

The combinatorial process sequence integration thus generates, for example, a semiconductor wafer 302 including a die array that has multiple dies 304. The dies 304 can be test dies and/or actual product dies containing intended integrated circuitry. Blanket wafers, pattern wafers, devices, functional chips, functional devices, test structures, semiconductors, integrated circuits, flat panel displays, optoelectronic devices, data storage devices, magnetoelectronic devices, magnetooptic devices, molecular electronic devices, solar cells, photonic devices, and packaged devices can be processed and/or generated using the aforementioned combinatorial process sequence integration methodology. The combinatorial process sequence integration can be applied to any desired segment(s) and/or portion(s) of an overall process flow. Characterization, including electrical testing, can be performed after each process step, and/or series of process steps within the process flow as needed and/or desired.

The SPS forms materials in one or more site isolation regions on the substrate using a number of different techniques. For example, the processing materials can be reacted using, for example, solution based synthesis techniques, photochemical techniques, polymerization techniques, template directed synthesis techniques, epitaxial growth techniques, by the sol-gel process, by thermal, infrared or microwave heating, by calcination, sintering or annealing, by hydrothermal methods, by flux methods, by crystallization through vaporization of solvent, etc. Other useful reaction techniques that can be used to react the processing materials of interest will be readily apparent to those of skill in the art.

Since the regions of the substrate are processed independently of each other, the processing conditions at different regions can be controlled independently. As such, process material amounts, reactant solvents, processing temperatures, processing times, processing pressures, the rates at which the reactions are quenched, deposition order of process materials, process sequence steps, etc. can be varied from region to region on the substrate. Thus, for example, when exploring materials, a processing material delivered to a first and a second region can be the same or different. If the processing material delivered to the first region is the same as the processing material delivered to the second region, this processing material can be offered to the first and second regions on the substrate at either the same or different concentrations. This is true as well for additional processing materials delivered to the first and second regions, etc. As with the processing material delivered to the first and second regions, the additional processing materials delivered to the first and second regions can be the same or different and, if the same, can be offered to the first and second regions on the substrate at either the same or different concentrations.

Moreover, within a given predefined region on the substrate, the processing materials can be delivered in either a uniform or gradient fashion. If the same processing materials are delivered to the first and second regions of the substrate at identical concentrations, then the conditions (e.g., reaction temperatures, reaction times, etc.) under which the regions are processed can be varied from region to region. Variable parameters include, for example, material amounts, solvents, process temperatures, process times, the pressures at which the processes are carried out, the atmospheres in which the processes are conducted, the rates at which the processes are quenched, the order in which the materials are deposited, etc. Other process parameters which can be varied will be apparent to those of skill in the art.

Moreover, an embodiment provides for forming at least two different arrays of materials by delivering substantially the same processing materials at approximately identical concentrations to corresponding regions on both first and second substrates having different surfaces, such as a dielectric material surface and an electrically conductive surface, in order to represent different portions of regions on an IC chip, and, thereafter, subjecting the process materials on the substrates to a first set of process conditions. Using this method, the effects of the process parameters or materials on the various substrate surfaces can be studied and, in turn, optimized.

The processing materials utilized in the processing of the individual regions must often be prevented from moving to adjacent regions. Most simply, this can be ensured by leaving a sufficient amount of space between the regions on the substrate so that the various processing materials cannot interdiffuse between regions. Moreover, this can be ensured by providing an appropriate barrier between the various regions on the substrate during processing. In one approach, a mechanical device or physical structure defines the various regions on the substrate. A wall or other physical barrier, for example, can be used to prevent the materials in the individual regions from moving to adjacent regions. This wall or physical barrier may be removed after the synthesis is completed. One of skill in the art will appreciate that, at times, it may be beneficial to remove the wall or physical barrier before screening the array of materials.

In other embodiments, the processing may be effected without the need of barriers which physically touch the substrate. For example, lasers, radiative lamps, UV radiation sources, other “point” sources can be used to process regions in a site addressable fashion as the area of modification is nominally smaller and/or equivalent in size to the discrete regions of interest on the substrate. In yet another embodiment, a physical barrier can be used to essentially screen and/or limit the processing to a desired region(s) and/or portion(s) of a region(s) wherein the physical barrier does not physically touch the substrate. For example, a physical barrier can be used to essentially block and/or restrict processing to certain region(s) and/or portion(s) or region(s). A screen, such as a mask or shutter, can be used to block vapor fluxes such as from PVD (i.e., sputtering) or evaporation sources for example. An opaque vs. transparent mask can be used to let certain radiation through the transparent regions to effect processing in specified regions on the substrate. In yet another embodiment, gas flows, of preferably an inert gas such as argon (Ar), can be used to screen out gaseous reagents and or limit the concentrations of such reagents so as to effectively screen out the effects of such reagents from certain regions. In this fashion, specific regions on a substrate can be processed differently without the need for a physical barrier in communication with the substrate. This approach is particularly amenable to sequential gas phase vacuum based surface kinetic processes such as atomic layer deposition and various forms thereof (e.g., ion, radical, and plasma induced/enhanced).

The SPSs of an embodiment include processing tools configured to provide both uniform processing across an entire substrate and independent processing of one or more discrete regions of the substrate individually. The processing tools described herein, which include operations under the combinatorial process sequence integration process flows described above with reference to FIGS. 2 and 3, can be a component of a substrate processing system like the SPS 100 described above and/or one or more modules of the SPS 100 described above with reference to FIG. 1. The combinatorial process sequence integration process flow 300 of FIG. 3 can be implemented in a processing module 102 of the SPS 100 shown in FIG. 1, for example. Similarly, the combinatorial process sequence integration process flow 300 can be implemented across one or more processing modules 101, 102, and 103 of the SPS 100, shown in FIG. 1.

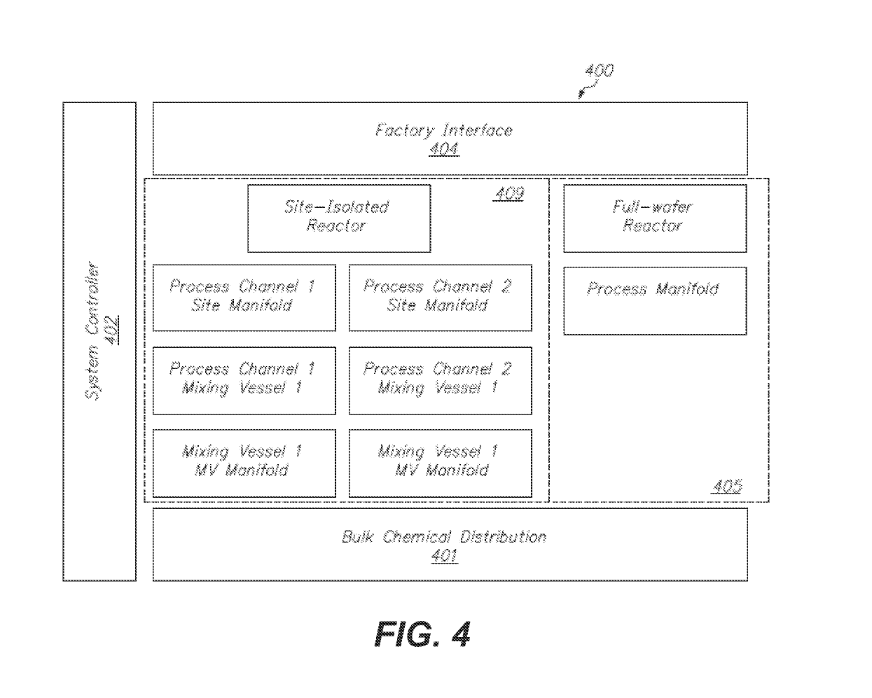

The SPSs of an embodiment includes an integrated processing tool that supports both full-wafer processing and combinatorial processing. FIG. 4 is a block diagram of the integrated processing tool 400, referred to herein as a Multiple Channel Site-Isolated Reactor (MCSIR) 400, in accordance with some embodiments. The MSCIR 400 may include a full-wafer processing module 405 and a site-isolated processing module (SIPM) 409, as described in detail below. The MCSIR 400 incorporates a bulk chemical distribution system 401 to provide the raw chemicals necessary to provide the process sequence, as well as chemical mixing and sequencing hardware. The bulk chemical distribution system 401 is in the form of mixing vessels and distribution manifolds to provide the ability to dynamically mix chemical solutions of any composition as well as to sequence the chemicals through the reactors in any order for any time duration. The MCSIR 400 is controlled using a computerized hardware controller, i.e., a system controller 402. The system controller 402 may be used to control processing in both the full-wafer reactor of the full-wafer processing module 405 and the site-isolated reactor of SIPM 409. Wafers are sequenced through the MCSIR 400 using a factory interface 404. The full-wafer and site-isolated reactors are comparable in all control aspects. Each reactor or channel of the MCSIR 400 is configured to allow the implementation of complex wet/vapor-process sequences as described herein.

Generally, the full-wafer processing module 405 includes a process manifold coupled to a full-wafer reactor. The process manifold is coupled to the bulk chemical distribution system 401 and is configured to feed or deliver the chemicals supplied from the bulk chemical distribution system 401 to the full-wafer reactor. The full-wafer reactor is configured to effect uniform processing across the entire wafer or substrate surface (e.g., 8-inch wafer, 12-inch wafer, etc.) using the delivered chemicals.

In contrast, the SIPM 409 is a site-isolated processor that enables independent processing of multiple discrete regions (e.g., 28 regions) across the wafer using multiple channels or process paths. These regions are also referred to herein as site isolated regions. This example of the SIPM 409 shows a single site-isolated reactor being fed by either of two process paths or channels for the sake of clarity of this example, but the MCSIR can include any number of site-isolated reactors and any number of process paths connected to each reactor.

The SIPM 409 feeds or distributes the chemicals 401 using a delivery system generally including a set or assembly of first manifolds (e.g., mixing vessel (MV) 1 manifold). An output of each first manifold is coupled to a mixing vessel (e.g., mixing vessel 1, etc.). The mixing vessel manifolds allow mixing of the bulk chemicals in any ratio for each of the mixing vessels, and the mixing vessels then serve as temporary storage for the mixed chemical solutions.

The output of each mixing vessel feeds one or more of a set of second manifolds (e.g., process channel 1 site manifold, process channel 2 site manifold). An output of each set of second manifolds feeds a site-isolated reactor. The set of second manifolds generally allows sequencing of the mixing vessel solutions and/or bulk chemicals through either of two process paths (e.g., channel 1, channel 2) in a set of flow cells. The flow cells comprise the top surface of the site-isolated reactor, and reactor sleeves comprise the side walls of the reactor. The processed substrate comprises the bottom of the reactor. Each site-isolated reactor effects individual processing of a dedicated region of the substrate as described herein.

The example of the MCSIR 400 does not include a mixing vessel in the process path for the full-wafer reactor. However, it is possible and sometimes desirable to include a mixing vessel in the full-wafer reactor process path in order to configure the full-wafer processing module in a manner similar to that of the SIPM.

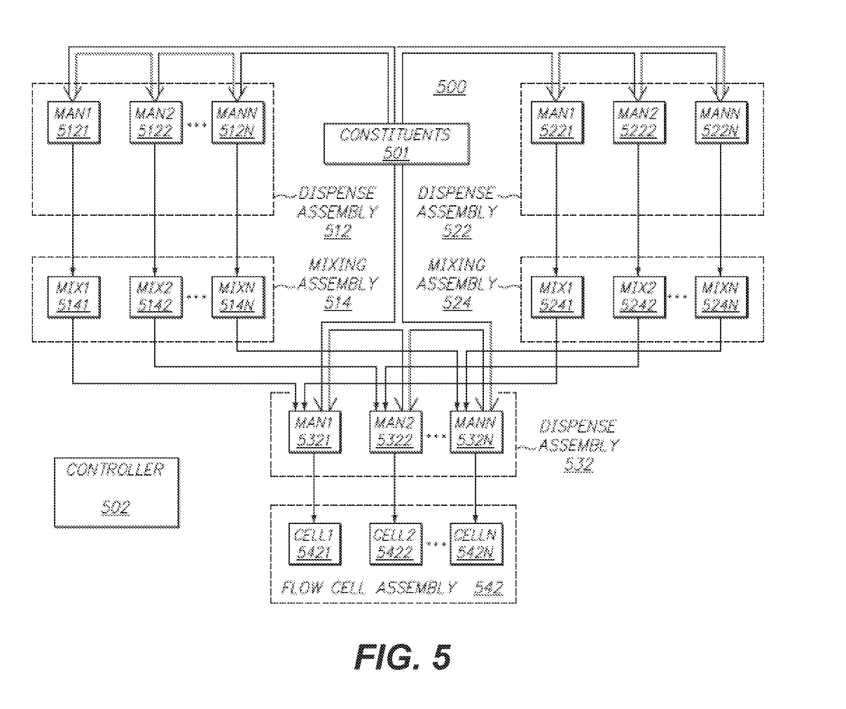

FIG. 5 is a SIPM 500 of a MCSIR, in accordance with some embodiments. The SIPM 500 manages or controls simultaneous processing of different regions of a substrate by simultaneously controlling reactions in multiple parallel reactors. Each of the reactors is located proximate to a particular region of a substrate (e.g., wafer). The reactor control includes controlling reagent flow, reagent mixing, reagent delivery, reagent and/or reactor temperature, and/or reagent pH to name a few.

The SIPM 500 includes a first dispense assembly 512 coupled to a first mixing assembly 514. The first dispense assembly 512 includes a number N of mixing vessel manifolds 5121-512N, where the number N of mixing vessel manifolds can be any number. The first dispense assembly 512 of an embodiment includes twenty-eight (28) mixing vessel manifolds, but the SPS is not limited to this number of mixing vessel manifolds and can include any number of mixing vessel manifolds. The inputs of each of the mixing vessel manifolds are coupled to one or more of the chemical sources, labeled as constituents 501 in FIG. 5. As an example, a mixing vessel manifold of an embodiment includes eight (8) inputs, and each of the inputs is connected to a different one of the chemicals 501. The mixing vessel manifolds are however not limited to eight (8) inputs, and each input is not limited to connection to a different constituent from any other manifold input. Additionally, all mixing vessel manifolds of the dispense assembly 512 are not limited to being of the same configuration. Furthermore, other components (e.g., valves, regulators, mixers, pumps, etc.) can be connected inline between the constituents and the mixing vessel manifolds.

The first mixing assembly 514 includes a number N of mixing vessels 5141-514N, where the number N of mixing vessels can be any number. The first mixing assembly 514 of an embodiment includes twenty-eight (28) mixing vessels, but the SPS is not limited to this number of mixing vessels and can include any number of mixing vessels. The inputs of each of the mixing vessels are coupled to outputs of the mixing vessel manifolds of the first dispense assembly 512. As an example, the mixing vessel of an embodiment includes one (1) input that is connected to an output of a mixing vessel manifold of the first dispense assembly 512. As a more specific example, an input of a first mixing vessel 5141 is connected to an output of a first mixing vessel manifold 5121. The mixing vessels are however not limited to one (1) input, and each input is not limited to connection to one mixing vessel manifold of the first dispense assembly 512.

The SIPM 500 further includes a second dispense assembly 522 coupled to a second mixing assembly 524. The second dispense assembly 522 includes a number N of mixing vessel manifolds 5221-522N, where the number N of mixing vessel manifolds can be any number. The second dispense assembly 522 of an embodiment includes twenty-eight (28) mixing vessel manifolds, but the SPS is not limited to this number of mixing vessel manifolds. The inputs of each of the mixing vessel manifolds are coupled to one or more of the chemicals 501. As an example, and as described above, the mixing vessel manifold of an embodiment includes eight (8) inputs, and each of the inputs is connected to a different one of the chemicals 501. The mixing vessel manifolds are however not limited to eight (8) inputs, and each input is not limited to connection to a different constituent from any other manifold input. Additionally, other components (e.g., valves, regulators, mixers, etc.) can be connected inline between the constituents and the mixing vessel manifolds.

The second mixing assembly 524 includes a number N of mixing vessels 5241-524N, where the number N of mixing vessels can be any number. The second mixing assembly 524 of an embodiment includes twenty-eight 28 mixing vessels, but the SPS is not limited to this number of mixing vessels. The inputs of each of the mixing vessels are coupled to outputs of the mixing vessel manifolds of the first dispense assembly 522. As an example, the mixing vessel of an embodiment includes one (1) input that is connected to an output of a mixing vessel manifold of the first dispense assembly 522. As a more specific example, an input of a first mixing vessel 5241 is connected to an output of a first mixing vessel manifold 5221. The mixing vessels are however not limited to one (1) input, and each input is not limited to connection one mixing vessel manifold of the first dispense assembly 522.

The SPS is modular so alternative embodiments of the SPS can include a different number of dispense assemblies and/or mixing assemblies. For example, the SPS of an alternative embodiment can include two additional dispense assemblies, with each additional dispense assembly coupled to an additional mixing assembly. As another example, the SPS of an alternative embodiment includes only the first dispense assembly 512 and first mixing assembly 514 described above, and does not include the second dispense assembly 522 and second mixing assembly 524. Furthermore, the SPS of alternative embodiments can include a smaller or larger number of mixing vessel manifolds and/or mixing vessels than described above. Additionally, alternative embodiments include different configurations of mixing vessel manifolds and/or mixing vessels; for example, two mixing vessel manifolds can be coupled to a single mixing vessel.

The SIPM 500 includes a third dispense assembly 532. The third dispense assembly 532 includes a number N of site manifolds 5321-532N, where the number N of site manifolds can be any number. The third dispense assembly 532 of an embodiment includes twenty-eight 28 site manifolds, but the SPS is not limited to this number of site manifolds. Each site manifold of an embodiment includes eight (8) inputs, but is not so limited. A first input of each site manifold is connected to an output of a mixing vessel of the first mixing assembly 514, and a second input of each site manifold is connected to an output of a mixing vessel of the second mixing assembly 524. Therefore, using a first manifold 5321 of the third dispense assembly 532 as a more specific example, a first input of the first site manifold 5321 is connected to an output of a first mixing vessel 5141 of the first mixing assembly 514, and a second input of the first site manifold 5321 is connected to an output of a first mixing vessel 5241 of the second mixing assembly 524. One or more of the remaining inputs of each site manifold of the third dispense assembly 532 is connected to one or more of the chemicals 501 as appropriate to the instant processing operations of the SIPM 500. Remaining inputs of each site manifold can however be coupled to other constituent sources in alternative embodiments. Other components (e.g., valves, regulators, mixers, pumps, etc.) can be connected inline between the constituents and the third dispense assembly 532.

Outputs of the third dispense assembly 532 are coupled to a flow cell assembly 542. The flow cell assembly 542, which is proximate to a substrate as described above, includes a number N of flow cells 5421-542N, where the number N of flow cells can be any number. As an example, the flow cell assembly 542 of an embodiment includes 28 flow cells, but the SPS is not limited to this number of flow cells. Each flow cell of an embodiment includes one (1) input, but is not so limited. The input of each flow cell is coupled to outputs of the site manifolds of the third dispense assembly 532. For example, the flow cell of an embodiment includes one (1) input that is connected to an output of a site manifold of the third dispense assembly 532. As a more specific example, an input of a first flow cell 5421 is connected to an output of a first site manifold 5321 of the third dispense assembly 532. The interior of the flow cells can be configured or reconfigured to tailor fluid flow; for example, the interior cavity can be any shape and/or the surface profiles of the interior can be varied so as to control velocities of fluids. Other components (e.g., valves, regulators, mixers, pumps, etc.) can be connected inline between the third dispense assembly 532 and the flow cell assembly 542.

The flow cell assembly 542 therefore includes a series of parallel cells forming site-isolated reactors configured to effect site-isolated processing on a proximate region of a substrate. The site-isolated processing includes processing comprising the constituents or compositions delivered to each cell or reactor of the flow cell assembly 542 as described above.

The embodiment of the SIPM 500 described above includes an equivalent number N of each of mixing vessel manifolds of the first dispense assembly 512, mixing vessel manifolds of the second dispense assembly 522, site manifolds of the third dispense assembly 532, mixing vessels of the first mixing assembly 514 and second mixing assembly 524, and flow cells of the flow cell assembly 542. As described above, however, alternative embodiments can include different numbers of one or more of the mixing vessel manifolds of the first dispense assembly 512, mixing vessel manifolds of the second dispense assembly 522, site manifolds of the third dispense assembly 532, mixing vessels of the first mixing assembly 514 and second mixing assembly 524, and flow cells of the flow cell assembly 542 as appropriate to a processing operations.

A controller 502 is coupled to various components of the SIPM 500 as described above and controls processing operations. The SIPM 500 generally provides processing operations that include global mixing of multiple constituents (e.g., chemicals, composition, etc.) to form a variety of combinations of compositions at each of the first mixing assembly 514 and the second mixing assembly 524. The compositions at this mixing level are delivered to the third dispense assembly 532 at which point additional constituents can be sequenced with the compositions; the resulting compositions are then delivered via the flow cells to a number N of parallel sites on a substrate. The SIPM 500, which supports liquid, gas, and/or plasma reagents, provides the resulting compositions under controlled conditions including controlling chemical composition, chemical sequencing, temperature, pH, in-line mixing, and local environment control to name a few. The SIPM 500 therefore enables flow control of various reagents (having various states) in such a manner as to effect continuous flow of reagents to numerous substrate site or regions in parallel. The SIPM 500 thus allows operators to effect parallel processing at different regions of a substrate while managing multiple flows, flow dynamics, and multiple channels using a minimum set of flow controls.

The SIPM 500 described above is modular and can include any number of any of the components described above. Components (e.g., dispense assembly, mixing vessel manifold, site manifold, mixing assembly, mixing vessels, flow cell assembly, flow cells) can be added or removed from the SIPM 500 as necessary to support processing operations. Furthermore, configurations of components include any number of configurations and are not limited to the configurations described above. For example, changing flow cell form factor (e.g., square instead of circular) involves changing only a top plate of the flow cell. Thus, the SPS is flexible in terms of configurability and ability to handle different types of processing.

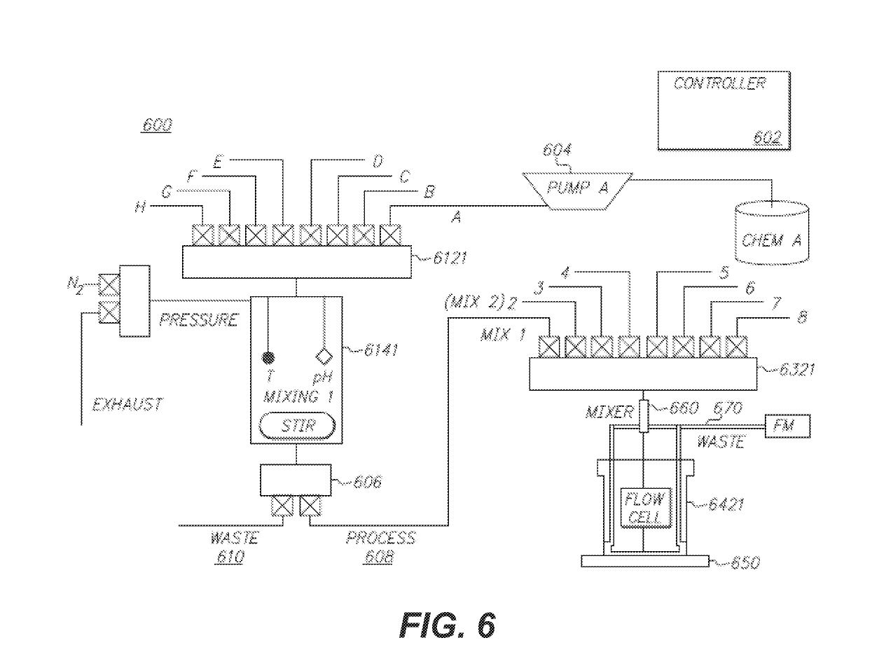

FIG. 6 shows couplings between a subset of components in a SIPM 600, in accordance with some embodiments. The SIPM 600 includes a first mixing vessel manifold 6121 that includes eight (8) inputs A-H. Each of the inputs is coupled to a constituent in order to selectively receive the constituents during processing operations. As one example of a connection between a constituent and the first mixing vessel manifold 6121, input A of the manifold 6121 is connected to chemical A via a pump 604. The pump 604 is a metering pump used to fill the vessels but is not so limited; alternative embodiments may not include the pump, may include multiple inline pumps, and/or may include a different type of pump. The pump 604 of an embodiment includes a metering pump that allows for precise control of volumetric ratios of each material but is not so limited. Other components (e.g., valves, regulators, mixers, pumps, etc.) can be connected inline between the container holding a constituent (e.g., chemical A) and the pump 604 and/or between the pump 604 and the manifold input A. Other MCSIR components and/or constituents or chemicals (not shown) can be coupled to inputs A-H of the first mixing vessel manifold 6121 in a similar fashion. The first mixing vessel manifold 6121 can be a component of a dispense assembly as described above, but is not so limited.

The SIPM 600 includes a mixing vessel 6141 having an input connected to the output of the first mixing vessel manifold 6121. The mixing vessel 6141 therefore receives the constituents flowed from the first mixing vessel manifold 6121. The mixing vessel 6141 of an embodiment allows for control of parameters under which a composition is generated in the vessel 6141, the parameters including pressure, temperature, and pH to name a few. The mixing vessel 6141 can include devices for stirring or agitating the received constituents. The mixing vessel 6141 includes or is coupled or connected to a flow mechanism 606 that functions to flow compositions from the mixing vessel 6141. As an example, the flow mechanism 606 includes connections for directing the composition to a process 608 or away from a process to waste 610; other routings (not shown) are possible. The mixing vessel 6141 can be a component of a mixing assembly as described above, but is not so limited.

The SIPM 600 includes a site manifold 6321 that includes eight (8) inputs 1-8. One of the inputs 1 is connected to receive the composition output MIX1 of the mixing vessel 6141. Other inputs of the site manifold 6321 can be connected to receive other constituents and/or compositions. For example, as described above, another input 2 of the site manifold 6321 can be connected to receive the composition output MIX2 of another manifold and/or mixing vessel. Further, other or remaining inputs 3-8 of the site manifold 6321 can be coupled to one or more other constituents (not shown).

Output of the site manifold 6321 is connected to a flow cell 6421 that is proximate to a region of a substrate 650. The SIPM 600 includes an optional inline mixer 660 between the site manifold 6321 and the flow cell 6421 for providing inline mixing. The flow cell 6421 receives the composition from the manifold 6321 and uses the composition to process the substrate region during the processing operations. The flow cell 6421 is connected to a waste line 670 that directs effluent (waste) away from the flow cell 6421. The waste line 670 can include a vacuum manifold or valve (not shown) for removing process effluent from the flow cell 6421. The flow cell 6421 can be a component of a flow cell assembly as described above, but is not so limited. A controller 602 is coupled to components of the SIPM 600 and controls processing operations as described below.

An embodiment of SIPM 600 includes a flow meter FM in the waste line in order to characterize the flow through the waste line rather than characterizing flow through the cell. This eliminates the need for numerous flow controllers and instead requires only one flow controller for a single solvent system; multiple flow controllers would be used with multiple solvent systems (e.g., three flow controllers used in system with acid, base and organic solvents).

The components of the SIPM, including the dispense assembly, mixing vessel manifold, mixing assembly, mixing vessels, flow cell assembly, and flow cell, vary in number and configuration as described above. These components are coupled or connected using a variety of other components and/or materials that include valves, tubing or conduit, dispense pumps, flow regulators, pressure regulators, and controllers to name a few. These other components and/or materials include components and/or materials known in the art as appropriate to the configuration and the processing operations.

The configuration of the SIPM described above allows bulk chemicals to be directed to a mixing vessel, through the mixing vessel manifold, and/or to the site-isolated reactor, through the site manifold. If directed to the mixing vessel, the control system enables mixing of solutions of arbitrary composition. The composition of the solution can be varied independently across each of the mixing vessels. The mixing vessels are implemented is such a fashion as to allow stirring, heating, and pH control of the resulting solutions. In addition, the pH and temperature of the resulting solutions can be monitored per flow cell. Furthermore, the flow rate of each solution through the site manifolds is independently variable.

As described above, each manifold (e.g., mixing vessel manifolds, site manifolds) includes a number of inputs or valves (e.g., X inputs, where X is any number 1, 2, . . . ), with each valve coupled or connected to a different chemical source. The chemical source may be liquid, gas or vacuum, for example. The manifold is configured so that the chemicals received at the manifold inputs exit the manifold through a common path. Consequently, the manifold is referred to as an X:1 manifold. The chemicals can be sequenced individually through the manifold or in combinations. When sequenced in combination, an in-line mixer can be used to ensure homogeneous chemical solutions. Check valves can also be incorporate at the entrance of each of the X chemicals to ensure that no backstreaming and, consequently, unwanted mixing of the chemicals occurs.

### Agitating System Examples

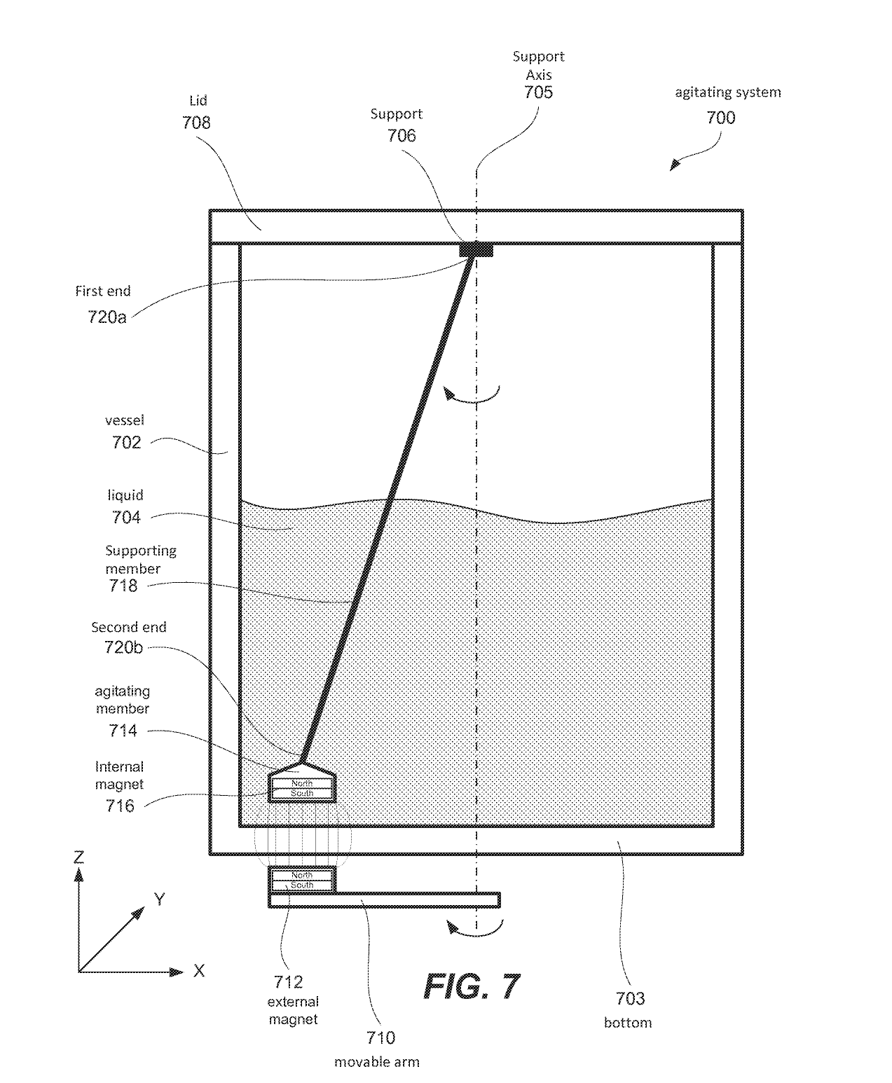

FIG. 7 is a schematic illustration of an agitating system 700, in accordance with some embodiments. The agitating system 700 may include a vessel 702 for containing liquid 704. The vessel 702 represents a mixing vessel 6141 shown in FIG. 6, which may be a part of either a mixing assembly 514 or a mixing assembly 524 shown in FIG. 4. Internal surfaces of the vessel 702 may be made from polymer materials, such as PTFE, PFA, PCTFE, ECTFE and the like. Vessels 702 may also be made of a metal or alloy and either coated or lined to provide protection from corrosive chemicals. A variety of suitable coatings or linings may be used, such as PTFE, ECTFE, FEP, Parylene and the like. Selection of these materials depends on composition of the liquid 704 contained in the vessel 702. For example, solutions containing hydrofluoric acid, which is commonly used for semiconductor processing, cannot be mixed in glass containers. Instead, PTFE containers or PTFE-lined containers are used instead. PTFE and many other polymer materials may not be sufficiently strong to resist wear caused by rubbing of conventional magnetic stirrers and can be easily damaged when contacted by moving parts. As such, the agitating system 700 does not allow its agitating member 714 to come in contact with the bottom 703 of the vessel 702. The contact with side walls of the vessel 702 is prevented by controlling paths of the agitating members 714. In some embodiments, the agitating member 714 does not come in contact with any internal surfaces of the vessel while its internal magnet 716 is magnetically coupled to the external magnet 712.

To prevent contact between the bottom 703 of the vessel 702 and the agitating member 714, the agitating system 700 includes support 706 to which the agitating member 704 is movably attached. The movable attachment may be provided by a supporting member 718 having a first end 720a attached to the support 706 and a second end attached to the agitating member 714. The supporting member 718 extends between the support 706 and the agitating member 714 and supports the weight, magnetic, and other forces acting on agitating member 714 thereby preventing the agitating member 714 to contact the bottom 703 of the vessel 702. It should be noted that, in some embodiments, the contact between the agitating member 714 and the bottom 703 may be prevented while the agitating member 714 or, more specifically, its internal magnet 716 is magnetically coupled to the external magnet 712. The agitating member 714 may be allowed to touch the bottom 703 when it is not magnetically coupled to the external magnet 712 and, for example, free hanging on the supporting member 718. For example, magnetic coupling may pull the agitating member 714 away from its free hanging position identified as a support axis 705. Depending on the angle formed by the support axis 705 and the supporting member 718, a gap between the agitating member 714 and the bottom 703 of the vessel 702 when the internal magnet 716 is coupled to the external magnet 712, and the length of the supporting member 718, the agitating member 714 may or may not touch the bottom 703 when it is not magnetically coupled to the external magnet (i.e., free hanging such that the supporting member 718 extends along the supporting axis). In some embodiments, the angle formed by the support axis 705 and the supporting member 718 when the agitating member 714 is magnetically coupled to the external magnet 712 is less than about 45° or, more specifically, less than about 30° or even less than about 15°.

In order to agitate the liquid 704, the agitating member 714 is moved within the vessel 702. Specifically, the internal magnet 716 of the agitating member 714 is magnetically coupled to the external magnet 712, and any movement of the external magnet 712 causes the corresponding movement of the agitating member 714. The external magnet 712 may be supported by a movable arm 710, which may be used to move the external magnet 712. The external magnet 712 and as a result the internal magnet 714 may move in a circular fashion, e.g., around the support axis 705. The agitating member 714 does not come in contact with the bottom 703 of the vessel 702 while being magnetically coupled and guided by the external magnet 712. For example, if the agitating member is moved in a circle around the support axis 705, the agitating member 714 may move within the plane perpendicular to this axis (i.e., the circular pattern of the agitating member 714 defining the plane). The plane may be parallel to the bottom 703 of the vessel 702 but not necessarily. For example, the support axis 705 may be perpendicular or at some other angle with respect to the bottom 703, which determines parallelism of the plane defined by the motion of the agitating member 714 and the bottom 703. In some embodiments, the distance between the plane defined by the motion of the agitating member 714 and the bottom 703 of the vessel 702 may be between about 1 millimeter and 2 millimeters. In some embodiments, the moving path and the support axis 705 are not concentric, and the agitating member 714 may also move in the direction of the supporting axis 705 (i.e., the vertical direction of the Z direction shown in FIG. 7) while being guided by the external magnet 712. This vertical motion may be used for additional agitation of the liquid 704. Even in this example, the contact between the bottom 703 and the agitating member 714 may be avoided when the agitating member 714 in its lowest position.

The movable arm 710 may move the external magnet 712 within a plane that is substantially parallel to the bottom 703 of the vessel 702 (i.e., the X-Y plane as shown in FIG. 4). The moving path of the external magnet 712 may be circular. Other paths may be used as well. As stated above, the path may be concentric with the support axis 705 or not. The rotational speed during agitation may be between 1 RPM and 1000 RPM. This speed may depend on viscosity of the liquid 704, size and profile of the agitating member 714, strength of the magnetic coupling between the internal and external magnets 712 and 716, and other factors.

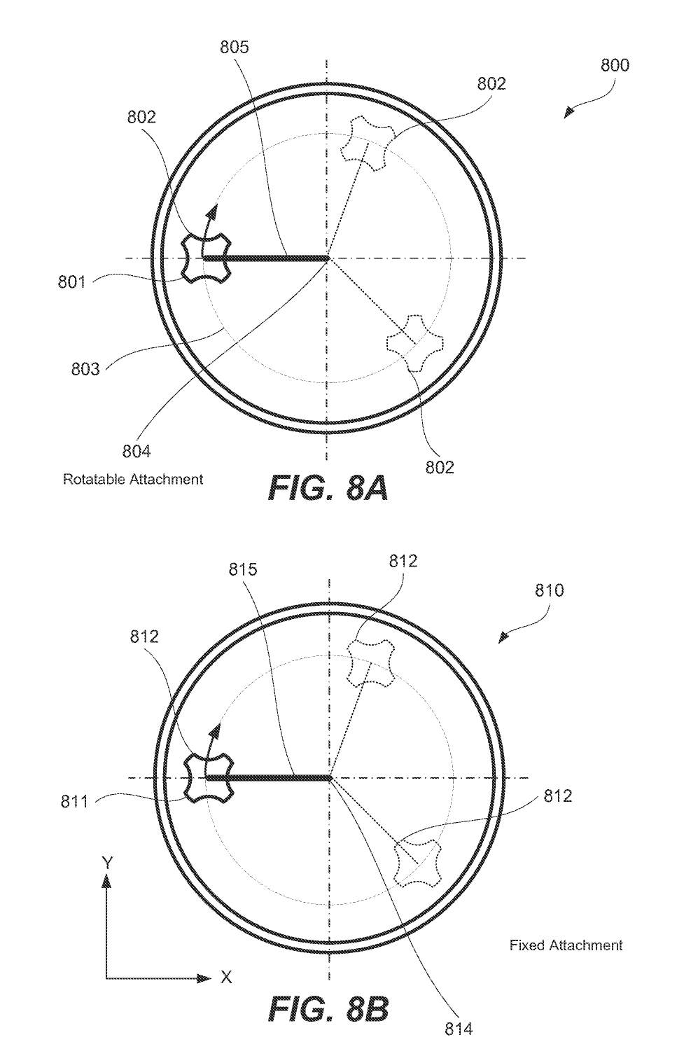

The support 706 may be provided on a lid 708 of the vessel 702 or some other components. The lid 708 may seal the vessel 702 from the external environment and may allow operating the vessel 702 at elevated or reduced pressure (e.g. typically between 0-15 psi, but could be between 0-80 psi). The support 706 may allow the supporting member 718 to rotate around its own axis (i.e., a rotatable attachment) or not (i.e., a fixed attachment) as will now be described with reference to FIGS. 8A and 8B.

Specifically, FIG. 8A is a schematic top view of an agitating system 800 having a supporting member 805 rotatably attached to a support 804, in accordance with some embodiments. The supporting member 805 is also attached to an agitating member 801, which moves along a circular path 803. FIG. 8A illustrates three positions of the agitating member 801 along this path 803 and respective positions of one corner 802 of the agitating member 801 in these three positions. The corner 802 maintains its orientation relative to the path 803 remaining as a leading outside corner.

FIG. 8B is a schematic top view of another agitating system 810 including supporting member 815 and support 814 having a fixed attachment, in accordance with some embodiments. The supporting member 815 is also attached to an agitating member 811, which also moves along a circular path 813 (that is similar to the path 803 shown in FIG. 8A). FIG. 8B illustrates three positions of the agitating member 811 along this path 813 and respective positions of one corner 812 of the agitating member 811 in these three positions. The corner 812 maintains its orientation relative to the X and Y axes. In other words, the agitating member 811 does not rotate within the X-Y plane. In the left position, the corner 812 is a leading outside corner. It then becomes a lagging outside corner (in the top right position shown in FIG. 8B) and a lagging inside corner (in the bottom right position). In some embodiments, the fixed attachment creates additional agitation in comparison to the rotatable attachment.

Similar results may be achieved using rotatable or fixed attachment between an agitating member and supporting member. In some embodiments, the fixed attachment is used.

Returning to FIG. 7, the agitating member 714 is held within the vessel 702 by the supporting member 718. The length of the supporting member 718 is selected in such a way that the agitating member does not contact the bottom 703 of the vessel 702 at least when the internal magnet of the agitating member 714 is magnetically coupled to the external magnet 712. In some embodiments, the length of the supporting member 718 is between about 2 inches and 6 inches, for example, about 4 inches. The supporting member 718 may be made from various materials that are capable to withstand exposure to the liquid 704 as some of the supporting member is typically submerged into the liquid 704 during operation of the system 700. The material may be compliant (i.e., flexible/bendable) or hard. When the hard non-compliant materials are used, the flexibility may be provided by attachment points at the first end 720a and/or at the second end 720b. In some embodiments, the supporting member 718 is made from a chemically resistant plastic material such as PFA or PTFE. The supporting member could also be made of a string, wire, cable, or rod of various materials such as Kevlar, titanium, stainless steel, and the like. The supporting member could be coated, if necessary, to protect it from corrosive liquids and vapors, such as a stainless steel wire coated with Parylene. The supporting member 718 may have a round cross-section and may have a diameter of between about one thirty-second and one eight of an inch, for example, one sixteenth of an inch. In some embodiments, the support members 718 includes agitating features provided between its first and second ends that help with additional agitation of the liquid.

As described above, at least some if not most of agitation of the liquid 704 is performed by the agitating member 714 provided inside the vessel 702 and submerged into the liquid 704 during operation. The agitating member 714 includes an internal magnet 716, which is magnetically coupled to the external magnet 712 during operation. The external magnet 712 drives the internal magnet 716 or, more generally, agitating member 714 along a predefined path thereby agitating the liquid 704. A permanent magnet may be used for the internal magnet 716 and, in some embodiments, for the external magnet 712. Some examples of such permanent magnets include Neodymium, Samarium Cobalt, Alnico, and the like. In some embodiments, the external magnet 712 is an electro-magnet, which may be turned on and off as needed. Furthermore, the strength of this type of a magnet may be adjusted based on viscosity, agitation speed, and other processing parameters.

Poles of both external magnet 712 and internal magnet 716 may be oriented along the axis that is substantially perpendicular to the bottom 703 of the vessel 702 (i.e., along the Z axis). This magnet orientation example is shown in FIG. 7. It allows the agitating member 714 to rotate around the axis defined by the supporting member 718. Other magnet orientations are possible as well. For example, poles of the external magnet 712 and internal magnet 716 may be oriented along the axes that are parallel to the bottom 703 of the vessel 702.

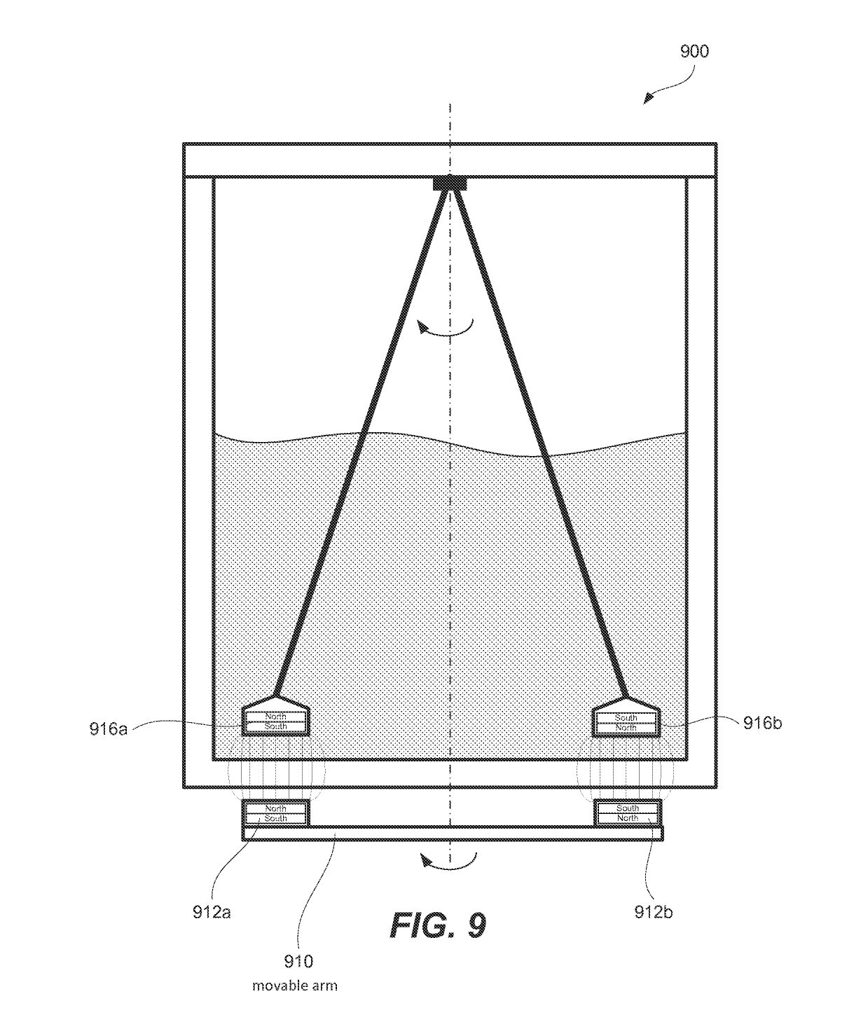

In some embodiments, an agitating system includes two external magnets that have different orientation of polarities, e.g., one magnet having a north pole facing the container and a south pole facing away from the container and another magnet having a north pole facing away from the container and a south pole facing the container. The axis defined by the poles of both magnets may be parallel and, in some embodiments, perpendicular to the bottom of the container. One such example is shown in FIG. 9. The two external magnets may be used when orientation of poles of the internal magnet with respect to the supporting member is unknown. As such, the internal magnet will couple with one of the external magnets and repel from another. Furthermore, the two external magnet configurations may be used to drive two internal magnets or, more generally, two agitating members each containing a separate external magnet as, for example, shown in FIG. 9. FIG. 9 is a schematic illustration of an agitating system 900 including two agitating members 916a and 916b, in accordance with some embodiments. The agitating member 916a is magnetically coupled to an external magnet 912a, while the agitating member 916b is magnetically coupled to an external magnet 912b. Each internal and external magnet may be specifically configured to couple to only one other magnet as, for example, shown in FIG. 9. Specifically, the internal magnet of the agitating member 916a is magnetically coupled to the external magnet 912a and will be repelled from the external magnet 912b. In a similar manner, the internal magnet of the agitating member 916b is magnetically couples to the external magnet 912b and will be repelled from the external magnet 912a. This configuration allows separate positioning of the two agitating member 916a and 916b within the vessel. In general, any number of internal and external magnets may be used in the same vessel.

Both external magnets 912a and 912b may be supported on the same movable arm 910 that is also used to move these magnets 912a and 912b. In some embodiments, each magnet may be supported on a separate arm independently movable relative to the other arm thereby independently controlling the motion of the two agitating members 916a and 916b.

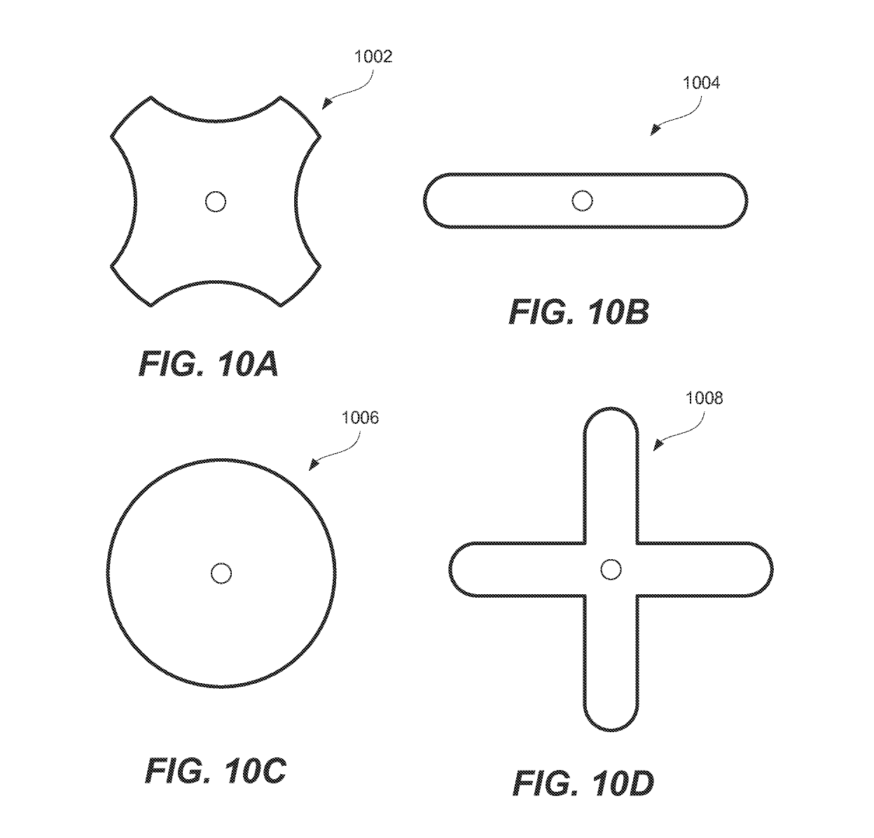

Returning to FIG. 7, the internal magnet 716 may be encapsulated into a protective shell made from PTFE, PFA, FEP, ECTFE and the like, or encapsulated with a thin protective coating such as Parylene The protective shell may isolate the internal magnet 716 from the liquid 704 during operation of the agitating system 714. Furthermore, the protective shell may define the shape of the agitating member 714. Some examples of such shapes are presented in FIGS. 10A-10B. Specifically, FIG. 10A is a schematic top view of an agitating member 1002 having multiple concave facets, in accordance with some embodiments. FIG. 10B is a schematic top view of a bar-shaped agitating member 1004, in accordance with some embodiments. FIG. 10C is a schematic top view of a round shaped agitating member 1002, in accordance with some embodiments. Finally, FIG. 10D is a schematic top view of a cross-shaped agitating member 1008, in accordance with some embodiments. Without being restricted to any particular theory, it is believed that the agitating member having multiple concave facets (element 1002) is believed to provide more agitation than, for example, the round shaped agitating member 1006. The orientation of the bar shaped agitating member 1004 may be difficult to control depending on orientation of the magnetic poles within the agitating members. In some embodiments, one magnetic pole may be positioned at one end of the bar shaped agitating member 1004, while the other pole—at the other end. Other shapes of agitating members may be used as well, such as square or triangular, where the individual facets aid in agitation.

### Processing Examples

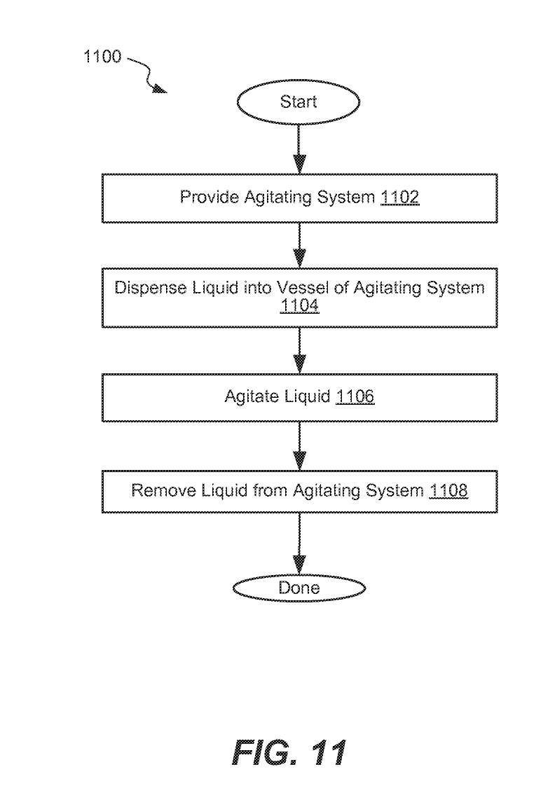

FIG. 11 is a process flowchart corresponding to a method 1100 of agitating a liquid using an agitating member, in accordance with some embodiments. The method 1100 may commence with providing an agitating system during operation 1102. Various examples of agitating systems are described above with reference to FIGS. 7-10. The provided agitating system may be a part of a Multiple Channel Site-Isolated Reactor (MCSIR) described above with reference to FIG. 4 or, more specifically, a part of a Site-Isolated Processing Module (SIPM) described above with reference to FIG. 5.

The method 1100 may proceed with dispensing the liquid into a vessel of the provided agitating system during operation 1104. Some embodiments use a plurality of vessels with approximately 100 ml internal volume per vessel. The method 1100 may proceed with agitating the liquid in the vessel during operation 1106. This operation involves moving an agitating member of the agitating systems within the vessel such that the agitating member does not touch the internal surfaces of the vessel. Various paths of the agitating member within the vessel are described above.

The method may then proceed with removing the agitated liquid from the system during operation 1108, for example, by pressurizing the space above the liquid. In some embodiments, this operation is performed while the liquid continues being agitated.

### CONCLUSION

Although the foregoing examples have been described in some detail for purposes of clarity of understanding, the invention is not limited to the details provided. There are many alternative ways of implementing the invention. The disclosed examples are illustrative and not restrictive.

What is claimed:

1. An agitating system comprising:
a vessel for storing a liquid, the vessel comprising a bottom;
a support provided above the vessel;
a movable arm provided below the vessel,
the movable arm comprising an external magnet movable within a plane substantially parallel to the bottom of the vessel;
an agitating member provided inside the vessel, the agitating member comprising an internal magnet magnetically coupled to the external magnet; and
a supporting member comprising a first end attached to the support and a second end attached to the agitating member,
the supporting member supporting the agitating member above the bottom of the vessel and preventing contact between the bottom and the agitating member while the internal magnet is magnetically coupled to the external magnet.

2. The agitating system of claim 1, wherein the supporting member is flexible.

3. The agitating system of claim 2, wherein the supporting member comprises one of PFA or PTFE.

4. The agitating system of claim 1, wherein the supporting member has a diameter of between one thirty-second and one eighth of an inch.

5. The agitating system of claim 1, wherein the supporting member is rigidly attached to the support.

6. The agitating system of claim 1, wherein the supporting member is rotatably attached to the support.

7. The agitating system of claim 1, wherein the internal magnet of the agitating member is encapsulated by one of PFA or PTFE.

8. The agitating system of claim 1, wherein magnetic poles of the internal magnet define an axis extending along one of or in between the following two directions: a first direction normal to the bottom of the vessel and a second direction defined by the first end and the second end of the supporting member.

9. The agitating system of claim 8, wherein an angled between the first direction and the second direction is less than 30 degrees.

10. The agitating system of claim 1, wherein the agitating member has a bar shape.

11. The agitating system of claim 1, wherein the agitating member has multiple concave facets.

12. The agitating system of claim 1, wherein the agitating member is separated from the bottom by between about 0.125 inches and 0.5 inches when the internal magnet is magnetically coupled to the external magnet.

13. The agitating system of claim 1, wherein the support is a part of a lid coupled to the vessel.

14. The agitating system of claim 13, wherein the lid and the vessel are configured to pressurize the liquid inside the vessel above the ambient pressure.

15. The agitating system of claim 1, wherein the movable arm comprises an additional external magnet and wherein orientations of magnetic poles of the external magnet and the additional external magnet are opposite to each other.

16. The agitating system of claim 1, wherein the supporting member prevents contact between the bottom and the agitating member when the internal magnet is not magnetically coupled to the external magnet.

17. The agitating system of claim 1, wherein an internal surface of the vessel comprises one of PFA or PTFE.

18. The agitating system of claim 1, wherein the external magnet is movable in a circular pattern leading the agitating member to follow a corresponding circular pattern inside the vessel.

19. An agitating system comprising:
a vessel for storing a liquid, the vessel comprising a bottom;
a support provided above the vessel;
a movable arm provided below the vessel,
the movable arm comprising an external magnet movable within a plane substantially parallel to the bottom of the vessel;
an agitating member provided inside the vessel, the agitating member comprising an internal magnet magnetically coupled to the external magnet; and
a supporting member comprising a first end attached to the support and a second end attached to the stirring member,
the supporting member supporting the agitating member above the bottom of the vessel and preventing contact between the bottom and the agitating member while the internal magnet is magnetically coupled to the external magnet.

20. A method of mixing a liquid provided in a container, the method comprising:
providing an agitating system, the agitating system comprising a vessel having a bottom, a support, a movable arm provided underneath the vessel and supporting an external magnet, an agitating member comprising an internal magnet magnetically coupled to the external magnet, and a supporting member supporting the agitating member above the bottom of the vessel and preventing contact between the bottom and the agitating member while the internal magnet is magnetically coupled to the external magnet,
dispensing liquid into the vessel of the agitating system; and
moving the external magnet within a plane parallel to the bottom of the vessel,
wherein moving the external magnet causes the agitating member to move within the vessel thereby agitating the liquid and such that the agitating member does not come in contact with vessel.
